(19) United States
(12) Patent Application Publication
(10) Pub. No.: US 2025/0291216 A1
(43) Pub. Date: Sep. 18, 2025

(54) DISPLAY DEVICE AND CONTROL METHOD FOR DISPLAY DEVICE

(71) Applicant: SEIKO EPSON CORPORATION, Tokyo (JP)

(72) Inventor: Hiroaki SHIMIZU, OKAYA-SHI (JP)

(73) Assignee: SEIKO EPSON CORPORATION, Tokyo (JP)

(21) Appl. No.: 19/078,273

(22) Filed: Mar. 12, 2025

(30) Foreign Application Priority Data
Mar. 15, 2024 (JP) 2024-041166

(51) Int. Cl. G02F 1/1337; G02F 1/1335

(52) U.S. Cl. CPC G02F 1/133788; G02F 1/133524

(57) ABSTRACT

A display device includes a light source; a liquid crystal panel including a display region on which light emitted from the light source is incident, the display region including a first substrate and a second substrate provided facing each other, and a liquid crystal layer provided between the first substrate and the second substrate, and a peripheral region in periphery of the display region; a light irradiation unit configured to irradiate a portion of the liquid crystal layer overlapping the peripheral region as viewed in a normal direction of the first substrate, with light of a first wavelength band; and a light detection unit configured to detect light of a long wavelength band longer than the first wavelength band emitted from the portion of the liquid crystal layer, when the light irradiation unit irradiates the portion of the liquid crystal layer with the light of the first wavelength band.

The present application is based on, and claims priority from JP Application Serial Number 2024-041166, filed Mar. 15, 2024, the disclosure of which is hereby incorporated by reference herein in its entirety.

### BACKGROUND

### 1. Technical Field

The present disclosure relates to a display device and a control method for the display device.

### 2. Related Art

In a projection-type display device, a transmission-type liquid crystal panel or a reflection-type liquid crystal panel is irradiated with light emitted from a light source, and transmitted light or reflected light modulated by the liquid crystal panel is projected onto a screen. Such a display device is likely to be degraded for reasons such as high intensity of the light emitted onto the liquid crystal panel from the light source.

For example, JP-A-2008-40016 discloses a liquid crystal display device in which the chromaticity or illuminance of a luminous flux emitted from a liquid crystal panel is detected by an optical sensor, and a cooling unit is controlled in accordance with the image quality state of an optical image determined based on a result of the detection.

For the display device described above, there has been a demand for efficient detection of degradation of the liquid crystal panel.

### SUMMARY

A display device according to an aspect of the present disclosure includes a light source, a liquid crystal panel, a light irradiation unit, and a light detection unit. The liquid crystal panel includes a display region on which light emitted from the light source is incident and a peripheral region in periphery of the display region. The display region includes a first substrate and a second substrate provided facing each other, and a liquid crystal layer provided between the first substrate and the second substrate. The light irradiation unit is configured to irradiate, with light of a first wavelength band, a portion of the liquid crystal layer overlapping the peripheral region as viewed in a normal direction of the first substrate. The light detection unit is configured to detect light of a long wavelength band longer than the first wavelength band emitted from the portion of the liquid crystal layer, when the light irradiation unit irradiates the portion of the liquid crystal layer with the light of the first wavelength band.

A control method for a display device according to an aspect of the present disclosure is a control method for a display device including a light source, a liquid crystal panel including a display region on which light emitted from the light source is incident and a peripheral region in periphery of the display region, and a light irradiation unit, wherein the display region includes a first substrate and a second substrate provided facing each other, and a liquid crystal layer provided between the first substrate and the second substrate, and the light irradiation unit is configured to irradiate, with light of a first wavelength band, a portion of the liquid crystal layer overlapping the peripheral region as viewed in a normal direction of the first substrate. The method includes detecting light of a long wavelength band longer than the first wavelength band emitted from the portion of the liquid crystal layer, when the light irradiation unit irradiates the portion of the liquid crystal layer with the light of the first wavelength band.

### BRIEF DESCRIPTION OF THE DRAWINGS

FIG. 1 is a diagram schematically illustrating a display device according to a first embodiment.

FIG. 2 is a plan view schematically illustrating a liquid crystal panel of the display device according to the first embodiment.

FIG. 3 is a cross-sectional view schematically illustrating the liquid crystal panel of the display device according to the first embodiment.

FIG. 4 is a plan view schematically illustrating the display device according to the first embodiment.

FIG. 5 is a cross-sectional view schematically illustrating the display device according to the first embodiment.

FIG. 6 is a graph for explaining how photoluminescence changes over time when a liquid crystal layer is irradiated with blue light.

FIG. 7 is a graph for explaining how the photoluminescence changes over time in an accelerated degradation test for the liquid crystal panel.

FIG. 8 is a graph for explaining how the photoluminescence changes over time in the accelerated degradation test for the liquid crystal panel.

FIG. 9 is a graph for explaining electro-optical characteristics of the liquid crystal panel.

FIG. 10 is a flowchart for explaining processing of a control unit of the display device according to the first embodiment.

FIG. 11 is a cross-sectional view schematically illustrating a display device according to a modification of the first embodiment.

FIG. 12 is a plan view schematically illustrating a display device according to a second embodiment.

FIG. 13 is a cross-sectional view schematically illustrating the display device according to the second embodiment.

FIG. 14 is a cross-sectional view schematically illustrating a display device according to a modification of the second embodiment.

FIG. 15 is a plan view schematically illustrating a display device according to a third embodiment.

FIG. 16 is a plan view schematically illustrating a display device according to a modification of the third embodiment.

FIG. 17 is a plan view schematically illustrating a display device according to a modification of the third embodiment.

### DESCRIPTION OF EMBODIMENTS

A preferred embodiment of the present disclosure is described in detail below with reference to the drawings. Note that the embodiments described below do not unduly limit the content of the present disclosure described in the claims. In addition, not all the configurations described below are essential constituent elements of the present disclosure.

### 1. First Embodiment

### 1.1. Display Device

### 1.1.1. Overall Configuration

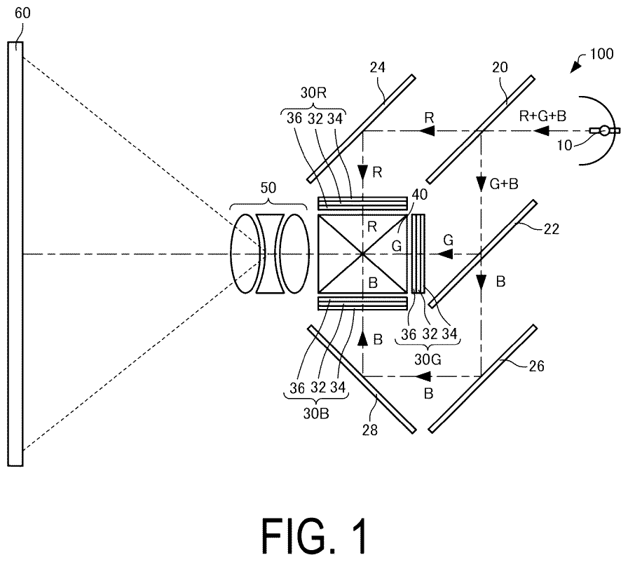

First, a display device 100 according to a first embodiment will be described with reference to the drawings. FIG. 1 is a diagram schematically illustrating the display device 100 according to the first embodiment.

As illustrated in FIG. 1, the display device 100 includes, for example, a light source 10, dichroic mirrors 20 and 22, reflection mirrors 24, 26, and 28, light modulation devices 30R, 30G, and 30B, a cross dichroic prism 40 serving as a light combining device, and a projection device 50. The display device 100 is, for example, a 3 Liquid Crystal Display (LCD) projector.

The light source 10 is, for example, an array light source including a semiconductor laser, or a lamp unit including a white light source such as an ultra-high pressure mercury lamp or a halogen lamp. Although not illustrated, an integrator lens that increases the uniformity of light emitted from the light source 10 may be provided.

Of the light emitted from the light source 10, red light (R) transmits through, and green light (G) and blue light (B) are reflected by the dichroic mirror 20. The green light (G) and the blue light (B), reflected by the dichroic mirror 20, are reflected by and transmits through the dichroic mirror 22, respectively.

The red light (R) reflected by the dichroic mirror 20 is incident on the light modulation device 30R after being reflected by the reflection mirror 24. The green light (G) reflected by the dichroic mirror 22 is incident on the light modulation device 30G. The blue light (B) transmitted through the dichroic mirror 22 is incident on the light modulation device 30B via the reflection mirrors 26 and 28.

The light modulation devices 30R, 30G, and 30B are disposed to face light incident surfaces for the light of respective colors of the cross dichroic prism 40. The light modulation devices 30R, 30G, and 30B include a liquid crystal panel 32, a first polarizing element 34, and a second polarizing element 36. The liquid crystal panel 32 is provided between the first polarizing element 34 and the second polarizing element 36. The liquid crystal panel 32 modulates the incident color light based on video information (video signal). The first polarizing element 34 controls the polarization of light incident on the liquid crystal panel 32. The second polarizing element 36 controls polarization of the light incident from the liquid crystal panel 32. The color light modulated by each of the light modulation devices 30R, 30G, and 30B is emitted toward the cross dichroic prism 40. The liquid crystal panel 32 will be described in detail below.

In the cross dichroic prism 40, four right-angle prisms are bonded together, and on inner surfaces of the prisms, a dielectric multilayer film configured to reflect the red light and a dielectric multilayer film configured to reflect the blue light are disposed in a cross shape. The T three types of color light are combined by these dielectric multilayer films to obtain light representing a color image. The light combined by the cross dichroic prism 40 is emitted toward the projection device 50.

The projection device 50 projects the combined incident light onto, for example, a screen 60. On the screen 60, an image is enlarged and displayed. The projection device 50 is formed by a projection lens for example.

In addition to a projector, the display device 100 is applicable to various types of electronic apparatuses such a liquid crystal panel of a light curing 3D printer, an electrical view finder (EVF), a mobile mini-projector, a head-up display, a smartphone, a mobile phone, a mobile computer, a digital camera, a digital video camera, a display, a vehicle-mounted unit, an audio unit, a light exposure device, or an illumination unit for example.

### 1.1.2. Liquid Crystal Panel

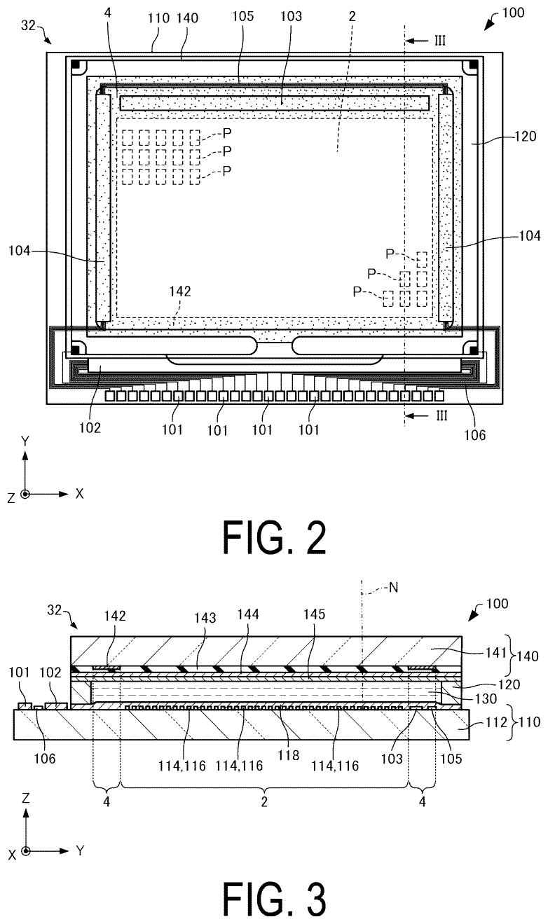

FIG. 2 is a plan view schematically illustrating the liquid crystal panel 32. FIG. 3 is a cross-sectional view, taken along line III-III in FIG. 2, schematically illustrating the liquid crystal panel 32.

The liquid crystal panel 32 is an active-drive type liquid crystal device including a thin film transistor (TFT) serving as a transistor for each pixel. As illustrated in FIG. 2 and FIG. 3, the liquid crystal panel 32 includes, for example, an element substrate 110, a sealing material 120, a liquid crystal layer 130, and a counter substrate 140.

As illustrated in FIG. 2, the element substrate 110 is larger than the counter substrate 140 as viewed in the normal direction of the element substrate 110 of the light modulation device 30B (hereinafter also simply referred to as “as viewed in the normal direction”). The element substrate 110 has a rectangular shape in plan view for example. In the example illustrated in FIG. 3, the normal direction is a direction in which a normal line N of a surface of a first support substrate 112 of the element substrate 110 on the liquid crystal layer 130 side extends, and is a Z-axis direction. In the illustrated example, the normal direction is a stacking direction of the element substrate 110 and the liquid crystal layer 130.

The element substrate 110 and the counter substrate 140 are joined by the sealing material 120. The sealing material 120 is provided along an outer edge of the counter substrate 140. The sealing material 120 surrounds the liquid crystal layer 130 as viewed in the normal direction. The sealing material 120 is adhesive such as thermosetting, light curable, electron-beam curable epoxy resin, for example. A display region 2 including a plurality of pixels P arrayed in a matrix manner is provided at the inside of the sealing material 120. The display region 2 is surrounded by a peripheral region 4. A partition portion 142 is provided in the peripheral region 4 and between the sealing material 120 and the display region 2 so as to surround the display region 2. Metal or metallic oxide having a light shielding property or the like is used as the material of the partition portion 142 for example.

The element substrate 110 includes, for example, an external coupling terminal 101, a data line driving circuit 102, an inspection circuit 103, a scanning line driving circuit 104, a first wire 105, and a second wire 106.

A plurality of the external coupling terminals 101 are provided. In the illustrated example, the plurality of external coupling terminals 101 are arrayed in an X-axis direction. The data line driving circuit 102 is provided between a first side along the plurality of external coupling terminals 101 and the sealing material 120. In addition, an inspection circuit 103 is provided between the display region 2 and the sealing material 120 along a second side opposed from the first side. The scanning line driving circuit 104 is provide between the display region 2 and the sealing material 120 along a third side and a fourth side that are perpendicular to the first side and are opposed to each other. Although not illustrated in the figures, the inspection circuit 103 may be provided between the display region 2 and the sealing material 120 along the data line driving circuit 102.

The first wire 105 is provided between the inspection circuit 103 and the sealing material 120 along the second side. The first wire 105 is coupled to two scanning line driving circuits 104. A plurality of the first wires 105 are provided. The second wire 106 is coupled to the data line driving circuit 102 and the scanning line driving circuit 104. The second wire 106 is electrically coupled to the plurality of external coupling terminals 101. A plurality of the second wires 106 are provided.

As illustrated in FIG. 3, the element substrate 110 includes, for example, the first support substrate 112, a pixel electrode 114, a TFT 116, and a first alignment layer 118.

The first support substrate 112 supports the pixel electrode 114, the TFT 116, and the first alignment layer 118. For example, the first support substrate 112 is a glass substrate, a quartz substrate, or the like. The light emitted from the light source 10 transmits through the first support substrate 112.

The pixel electrode 114 and the TFT 116 are provided on the liquid crystal layer 130 side of the first support substrate 112. The pixel electrode 114 and the TFT 116 are provided for each pixel P. A plurality of the pixel electrodes 114 and of the TFTs 116 are provided so as to correspond to the plurality of the pixels P. The pixel electrode 114 and the TFT 116 form the pixel P. The pixel electrode 114 is, for example, a transparent electrode made of indium tin oxide (ITO), indium zinc oxide (IZO), or the like. The TFT 116 is a switching element.

The first alignment layer 118 is provided on the liquid crystal layer 130 side of the first support substrate 112. The first alignment layer 118 covers the first support substrate 112, the pixel electrode 114, the TFT 116, and the first wire 105. The first alignment layer 118 is, for example, an inorganic alignment layer such as a silicon oxide layer or an organic alignment layer such as a polyimide layer.

The liquid crystal layer 130 is provided between the element substrate 110 and the counter substrate 140. A liquid crystal having positive or negative dielectric anisotropy is incorporated in a space between the element substrate 110 and the counter substrate 140 to provide the liquid crystal layer 130.

The counter substrate 140 is provided on the side of the liquid crystal layer 130 opposite to the element substrate 110. The counter substrate 140 faces the element substrate 110. Light emitted from the light source 10 is incident on the counter substrate 140.

The counter substrate 140 includes, for example, a second support substrate 141, the partition portion 142, an insulating layer 143, a counter electrode 144, and a second alignment layer 145.

The second support substrate 141 faces the first support substrate 112. The second support substrate 141 supports the partition portion 142 and the insulating layer 143. For example, the second support substrate 141 is a glass substrate, a quartz substrate, or the like. The light emitted from the light source 10 transmits through the second support substrate 141. For example, the second support substrate 141 has a smaller area than the first support substrate 112 as viewed in the normal direction.

The partition portion 142 is provided on the liquid crystal layer 130 side of the second support substrate 141. As illustrated in FIG. 2, the partition portion 142 overlaps the inspection circuit 103 and the scanning line driving circuit 104 as viewed in the normal direction. Specifically, light incident from the counter substrate 140 side is blocked by the partition portion 142 so as not to be incident on peripheral circuits such as the inspection circuit 103 and the scanning line driving circuit 104. This makes it possible to suppress malfunction of the peripheral circuits. In addition, the partition portion 142 also suppresses unwanted entrance of stray light into the display region 2. This makes it possible to suppress a reduction in the contrast of the liquid crystal panel 32.

As illustrated in FIG. 3, the insulating layer 143 is provided on the liquid crystal layer 130 side of the second support substrate 141. The insulating layer 143 covers the partition portion 142. The insulating layer 143 is provided between the liquid crystal layer 130 and the second support substrate 141. The surface of the insulating layer 143 on the liquid crystal layer 130 side is, for example, a flat surface. The light emitted from the light source 10 transmits through the insulating layer 143. The insulating layer 143 is a silicon oxide layer or the like for example.

The counter electrode 144 is provided on the liquid crystal layer 130 side of the insulating layer 143. The counter electrode 144 is provided between the liquid crystal layer 130 and the insulating layer 143. The counter electrode 144 is a transparent electrode made of, for example, ITO, IZO, or the like.

The second alignment layer 145 is provided on the liquid crystal layer 130 side of the counter electrode 144. The liquid crystal layer 130 is provided between the first alignment layer 118 and the second alignment layer 145. The second alignment layer 145 is, for example, an inorganic alignment layer such as a silicon oxide layer or an organic alignment layer such as a polyimide layer.

The optical design of a normally white mode or normally black mode is employed for the liquid crystal panel 32. In the normally white mode, the transmittance of the pixel P with no voltage application is greater than the transmittance with voltage application. In the normally black mode, the transmittance of the pixel P with no voltage application is smaller than the transmittance with voltage application.

The liquid crystal panel 32 which is of a transmission-type in the example illustrated in FIG. 1, may also be of a reflection-type.

### 1.1.3. Degradation Product of Liquid Crystal Layer, Light Irradiation Unit, and Light Detection Unit

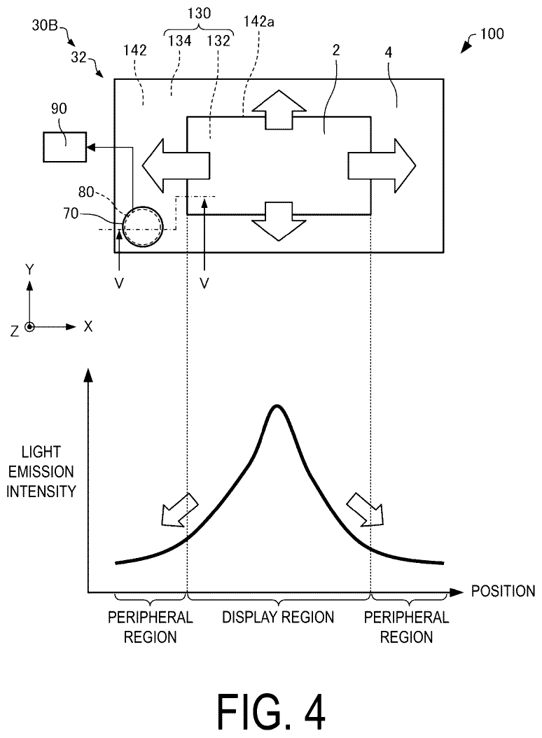

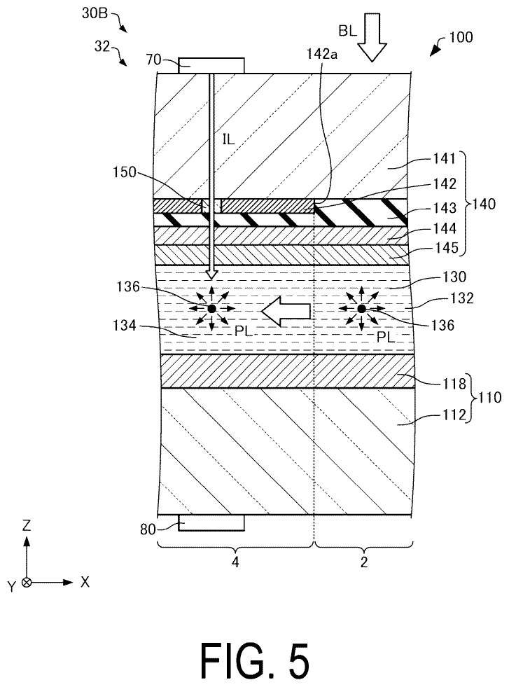

FIG. 4 is a plan view schematically illustrating the display device 100. FIG. 5 is a cross-sectional view taken along line V-V in FIG. 4, schematically illustrating the display device 100. For the sake of convenience, in FIG. 4 and FIG. 5, members other than the liquid crystal panels 32, a light irradiation unit 70, and a light detection unit 80 of the light modulation device 30B on which blue light is incident are not illustrated. For the sake of convenience, FIG. 4 illustrates the liquid crystal panel 32 in a simplified manner.

As illustrated in FIG. 4 and FIG. 5, the display device 100 includes the light irradiation unit 70 and the light detection unit 80. The liquid crystal layer 130 includes a first portion 132 and a second portion 134.

The first portion 132 of the liquid crystal layer 130 is a portion that overlaps the display region 2 of the liquid crystal panel 32 as viewed in the normal direction. The light emitted from the light source 10 is incident on the display region 2. The first portion 132 has a rectangular shape as viewed in the normal direction for example. Blue light BL emitted from the light source 10 is incident on the first portion 132.

The second portion 134 of the liquid crystal layer 130 is a portion that overlaps the peripheral region 4 of the liquid crystal panel 32 as viewed in the normal direction. The peripheral region 4 is a region in the periphery of the display region 2. The liquid crystal panel 32 includes the display region 2 and the peripheral region 4. The peripheral region 4 is a region more on the outer side than an inner edge 142a of the partition portion 142 serving as a light shielding layer, as viewed in the normal direction. The inner edge 142a is a boundary between the peripheral region 4 and the display region 2. The peripheral region 4 is a non-display region where no image is displayed. The partition portion 142 has a plate shape for example. The second portion 134 is continuous with the first portion 132.

As illustrated in FIG. 5, when the first portion 132 of the liquid crystal layer 130 is irradiated with the blue light BL from the light source 10 for a certain period of time, a liquid crystal degradation product 136 is produced. The liquid crystal degradation product 136 radiates light PL upon being irradiated with the blue light BL. The light PL is light of a long wavelength band longer than that of the blue light BL. The wavelength of the light PL is 550 nm or more and 650 nm or less for example. The wavelength of the light PL may be 600 nm or more and 650 nm or less. The wavelength of the blue light BL is 430 nm or more and 490 nm or less, for example. The light PL is, for example, red light. The light PL is fluorescence in the liquid crystal degradation product 136. More specifically, the light PL is photoluminescence (phosphorescence) in the liquid crystal degradation product 136. The light PL is substantially isotropically radiated from the liquid crystal degradation product 136.

The liquid crystal degradation product 136 produced in the first portion 132 of the liquid crystal layer 130 diffuses into the second portion 134 of the liquid crystal layer 130. White arrows in FIG. 4 indicate the diffusion of the liquid crystal degradation product 136 from the first portion 132 to the second portion 134. In the graph of FIG. 4, the horizontal axis indicates the position in the liquid crystal panel 32, and the vertical axis indicates the emission intensity of the light PL from the liquid crystal degradation product 136. The emission intensity indicated by the vertical axis is equivalent to the concentration of the liquid crystal degradation product 136, and the liquid crystal degradation product 136 diffuses from the first portion 132 with a high concentration toward the second portion 134 with a low concentration. Since the second portion 134 is not irradiated with the blue light BL from the light source 10, the radiation of the light PL due to the blue light BL from the liquid crystal degradation product 136 present in the second portion 134 does not occur.

The light irradiation unit 70 irradiates the second portion 134 of the liquid crystal layer 130 with light IL. As a result, the liquid crystal degradation product 136 present in the second portion 134 radiates the light PL. When the second portion 134 is irradiated with the light IL by the light irradiation unit 70, the light detection unit 80 detects the light PL emitted from the second portion 134.

The light irradiation unit 70 overlaps the second portion 134 of the liquid crystal layer 130 as viewed in the normal direction. As illustrated in FIG. 5, the counter substrate 140 is provided with the light irradiation unit 70. The light irradiation unit 70 is provided on, for example, a side of the counter substrate 140 opposite to the liquid crystal layer 130. In the illustrated example, the light irradiation unit 70 is provided on a surface of the counter substrate 140 in a +Z-axis direction. The light irradiation unit 70 is a light emitting diode (LED) or a laser for example.

The light IL emitted from the light irradiation unit 70 transmits through a window portion 150 provided in the partition portion 142 to be incident on the second portion 134 of the liquid crystal layer 130. The window portion 150 is provided in a through hole formed in the partition portion 142. The material of the window portion 150 is, for example, glass.

The wavelength of the light IL emitted from the light irradiation unit 70 is, for example, 400 nm or more and 490 nm or less, preferably 420 nm or less. The light IL may be light of a short wavelength band shorter than that of the blue light BL incident on the first portion 132. The light IL may be blue light or violet light. The light PL radiated from the liquid crystal degradation product 136 is light of a long wavelength band longer than the wavelength of the light IL. The intensity of the light IL emitted from the light irradiation unit 70 is lower than, for example, the intensity of the blue light BL incident on the first portion 132 of the liquid crystal layer 130.

The light detection unit 80 overlaps the second portion 134 of the liquid crystal layer 130 as viewed in the normal direction. The light detection unit 80 overlaps the light irradiation unit 70 as viewed in the normal direction. The element substrate 110 is provided with the light detection unit 80. The light detection unit 80 is provided on, for example, a side of the element substrate 110 opposite to the liquid crystal layer 130. In the illustrated example, the light detection unit 80 is provided on a surface of the element substrate 110 in a −Z-axis direction. The light detection unit 80 is, for example, a photodiode, a camera, a spectrometer, or the like.

A wavelength filter (not illustrated) may be provided between the light detection unit 80 and the liquid crystal layer 130. The wavelength filter reduces, for example, light of 400 nm or more and 600 nm or less. The light IL incident on the light detection unit 80 can be reduced by the wavelength filter. The wavelength filter may completely block the light IL.

The light detection unit 80 transmits the detection result to a control unit 90. The control unit 90 is provided in the display device 100 for example. The control unit 90 includes, for example, an integrated circuit (IC). The control unit 90 acquires a detection signal from the light detection unit 80. The control unit 90 executes processing of determining the degradation level of the liquid crystal panel 32 based on the acquired detection signal. Specific processing executed by the control unit 90 will be described below.

### 1.4. Change in Liquid Crystal Panel Over Time and Photoluminescence

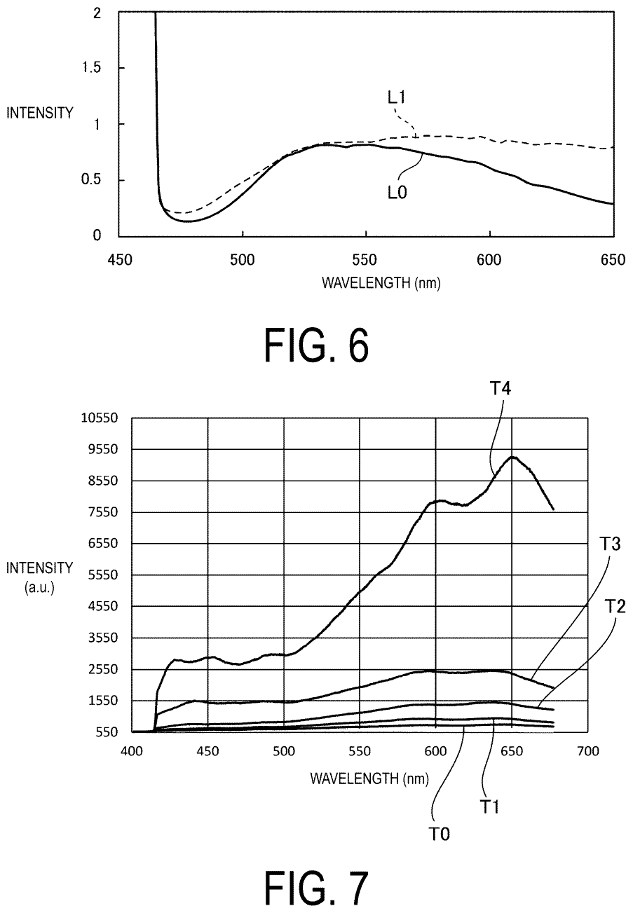

FIG. 6 is a graph for explaining a change in photoluminescence over time, when the liquid crystal layer is irradiated with the blue light. In FIG. 6, the horizontal axis indicates a measured wavelength, and the vertical axis indicates the intensity observed in the liquid crystal layer irradiated with blue light. A solid line L0 indicates an initial spectrum at the point when the liquid crystal layer is started to be irradiated with the blue light, and a broken line L1 indicates a spectrum at a point when the liquid crystal layer has been irradiated with the blue light for a certain period of time. It is presumed that the spectra other than the spectrum corresponding to the incident light are based on photoluminescence of the liquid crystal degradation product which is a degraded liquid crystal molecule. FIG. 6 and FIG. 7 to FIG. 9 described below illustrate a case where both blue light and photoluminescence are detected.

As illustrated in FIG. 6, when the liquid crystal layer is continuously irradiated with blue light having an intensity peak in the vicinity of the 450 nm for a certain period of time, the intensity of the spectrum of radiation light emitted from the liquid crystal layer increases. In particular, the intensity of a wavelength band from 550 nm to 650 nm increases, resulting in the radiation light being observed as light with an increased proportion of red component. When electrons transit between liquid crystal molecules, predetermined light is radiated. It is presumed that when liquid crystal molecules degraded by a photochemical reaction or the like are interposed, radiation light including phosphorescence with a wavelength from 550 nm to 650 nm is emitted.

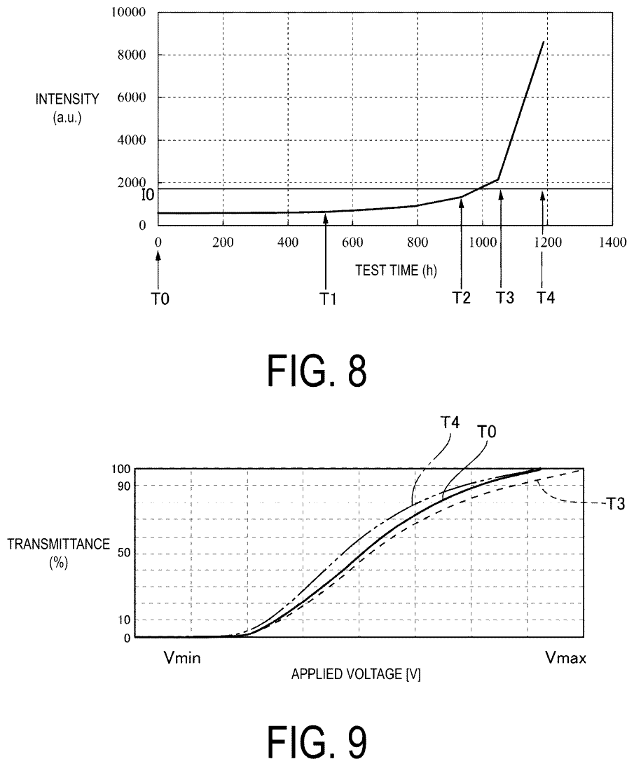

FIG. 7 and FIG. 8 are graphs for explaining a change in photoluminescence over time in an accelerated degradation test for a liquid crystal panel. FIG. 7 illustrates spectra respectively corresponding to test times T0, T1, T2, T3, and T4. In FIG. 7, the horizontal axis indicates the measured wavelength, and the vertical axis indicates light intensity observed in the liquid crystal panel. FIG. 8 illustrates a change in the light intensity in a band from 500 nm to 650 nm over time. In FIG. 8, the horizontal axis indicates the test times, and the vertical axis indicates the light intensity observed in the liquid crystal panel. FIG. 8 illustrates points corresponding to the test times T0, T1, T2, T3, and T4 illustrated in FIG. 7. In the accelerated degradation test illustrated in FIG. 7 and FIG. 8, the liquid crystal panel was irradiated with blue light having a high luminous flux density, and was observed from the light incident side.

FIG. 9 is a graph for explaining electro-optical characteristics (V-T characteristics) of the liquid crystal panel. In FIG. 9, the vertical axis indicates the transmittance and the horizontal axis indicates the voltage applied to the liquid crystal panel. FIG. 9 illustrates V-T curves of the liquid crystal panel respectively corresponding to the test times T0, T3, and T4.

The main cause of a change in light intensity over time observed in the liquid crystal panel is a change in the photoluminescence intensity of the liquid crystal panel over time. The test time T0 indicates an initial state, and T0<T1<T2<T3<T4 holds. The irradiation with the blue light increases the intensity of the spectrum of the radiation light from the photoluminescence of the liquid crystal. At the test times T1 and T2, the intensity of photoluminescence from the liquid crystal panel increases in the band from 500 nm to 650 nm. At the test times T3 and T4, the intensity of photoluminescence further increases over the entire measured wavelength band, and the intensity of photoluminescence significantly increases in the band from 500 nm to 650 nm. The test times T3 and T4 are respectively 1.1 times and 1.2 times longer than the test time T2. The intensities of photoluminescence with the test times T3 and T4 are respectively 1.5 times and 3 times or more the intensity of photoluminescence with the test time T2. The V-T curve of the liquid crystal panel at the test time T3 changes toward the darker side, and the V-T curve of the liquid crystal panel at the test time T4 changes toward the brighter side, meaning that the display quality of the liquid crystal panel is compromised. It can be seen that the liquid crystal panels rapidly degrades from the test time T3. Therefore, the degradation of the liquid crystal panel can be recognized from a change in the intensity of the photoluminescence of the liquid crystal panel.

It is presumed that the increase in the intensity of photoluminescence of the liquid crystal panel is caused by an increase in the concentration of degraded liquid crystal molecules. After the test time T4, the liquid crystal molecules are further degraded. As a result, the display quality of the liquid crystal panel cannot be recovered even by correction or the like, meaning that the service life of the liquid crystal panel ends. For example, as illustrated in FIG. 8, the service life of the liquid crystal panel is determined to have ended at a point when an intensity I0 of the photoluminescence, observed between the test time T2 and the test time T3, is detected. The intensity I0 of the photoluminescence can be set to a limit value I0 corresponding to the liquid crystal panel.

Therefore, by detecting the intensity of the photoluminescence radiated from the liquid crystal panel 0, it is possible to monitor the degradation of the liquid crystal layer and the degradation of the liquid crystal panel caused by the degradation of the liquid crystal layer. When the liquid crystal is continuously irradiated with the blue light for a certain period of time, the radiation light radiated from the liquid crystal panel includes fluorescence with a wavelength from 600 nm to 650 nm. A shorter wavelength of the light with which the liquid crystal is irradiated is likely to lead to faster degradation due to photochemical reaction or the like.

### 1.5. Control Method

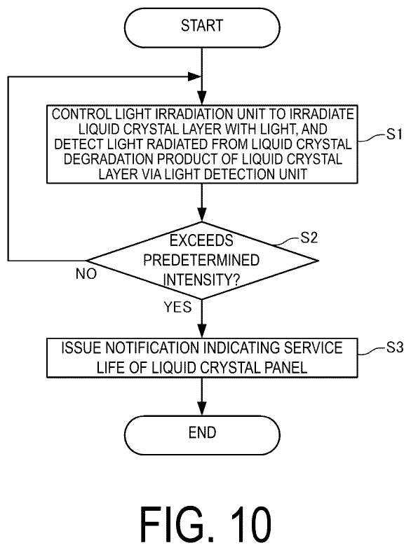

Next, a control method for the display device 100 according to the first embodiment will be described with reference to the drawings. Specifically, the processing of the control unit 90 of the display device 100 will be described. FIG. 10 is a flowchart for explaining the processing of the control unit 90.

The control unit 90 starts the processing when a signal for starting the processing is input via an operation unit (not illustrated).

First, as illustrated in FIG. 10, the control unit 90 executes processing of controlling the light irradiation unit 70 to irradiate the liquid crystal layer 130 with the light IL and making the light detection unit 80 detect the light PL radiated from the liquid crystal degradation product 136 of the liquid crystal layer 130 in response to the irradiation with the light IL (step S1).

Next, the control unit 90 executes processing of determining whether the intensity of the detected light PL exceeds a predetermined value (step S2). The predetermined value may be set in consideration of the limit value I0 illustrated in FIG. 8.

When the control unit 90 determines that the intensity of the light PL does not exceed the predetermined value (“NO” in step S2), the processing returns to step S2. Then, steps S1 and S2 are repeated until it is determined in step S2 that the intensity of the light PL exceeds the predetermined value.

On the other hand, upon determining that the intensity of the light PL exceeds the predetermined value (“YES” in step S2), the control unit 90 executes processing of issuing a notification related to the service life of the liquid crystal panel 32 (step S3). Specifically, the control unit 90 executes processing of issuing a notification indicating that the service life of the liquid crystal panel 32 has ended, or indicating a period until the service life ends. How the notification is issued is not particularly limited. For example, upon receiving the notification from the control unit 90, a user performs maintenance for the liquid crystal panel 32.

Then, the control unit 90 terminates the processing.

Upon determining that the intensity of the light PL exceeds the predetermined value, the control unit 90 may execute correction processing of reducing the intensity of the light PL so as not to exceed the predetermined value. For example, the control unit 90 may transmit a control signal to the light source 10 to reduce the output of the light source 10. For example, by reducing the output of the light source 10, an interval until the maintenance by the user can be increased.

### 1.6. Effects

The display device 100 includes the light source 10, the liquid crystal panel 32 including the display region 2 on which light emitted from the light source 10 is incident, the display region 2 including the element substrate 110 as a first substrate and the counter substrate 140 as a second substrate provided facing each other, and the liquid crystal layer 130 provided between the element substrate 110 and the counter substrate 140, and the peripheral region 4 in periphery of the display region 2, the light irradiation unit 70 configured to irradiate, with the light IL of a first wavelength band, the second portion 134 as a portion of the liquid crystal layer 130 overlapping the peripheral region 4 as viewed in a normal direction, and the light detection unit 80 configured to detect the light PL of a long wavelength band longer than the first wavelength band emitted from the second portion 134 of the liquid crystal layer 130, when the light irradiation unit 70 irradiates the second portion 134 of the liquid crystal layer 130 with the light IL of the first wavelength band.

Therefore, in the display device 100, the light irradiation unit 70 can emit light suitable for detection as compared with a case where the light PL emitted by the light emitted from the light source is detected. For example, the intensity of the light IL emitted from the light irradiation unit 70 can be made lower than that of the light emitted from the light source 10. Thus, the degradation of the liquid crystal panel 32 can be efficiently detected.

In the display device 100, the light irradiation unit 70 and the light detection unit 80 overlap the second portion 134 of the liquid crystal layer 130 as viewed in the normal direction. Thus, according to the display device 100, incidence of the light that is emitted from the light source 10 on the light detection unit 80 can be suppressed. Thus, the degradation of the liquid crystal panel 32 can be accurately detected.

In the display device 100, the light irradiation unit 70 is provided on the side of the counter substrate 140 opposite to the liquid crystal layer 130, and the light detection unit 80 is provided on the side of the element substrate 110 opposite to the liquid crystal layer 130. Therefore, for example, compared with a case where the light irradiation unit and the light detection unit are provided on the liquid crystal layer side, it is possible to reduce an impact of the installation of the light irradiation unit 70 and the light detection unit 80 on the liquid crystal layer 130.

Although not illustrated, the light irradiation unit 70 may be provided in the counter substrate 140, and the light detection unit 80 may be provided in the element substrate 110.

### 1.2. Modification of Display Device

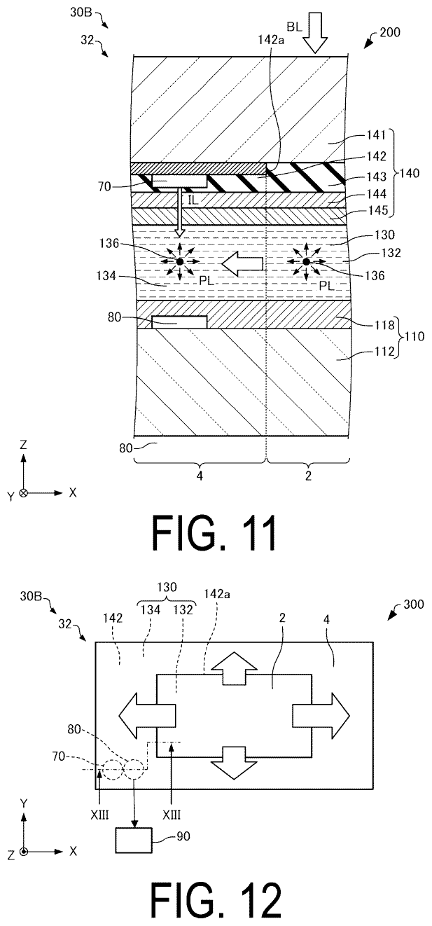

Next, a display device according to a modification of the first embodiment is described with reference to the drawing. FIG. 11 is a cross-sectional view schematically illustrating a display device 200 according to the modification of the first embodiment.

In the following description, in the display device 200 according to the modification of the first embodiment, members having the same functions as the constituent members of the display device 100 described above are denoted by the same reference signs, and detailed description thereof is omitted.

In the display device 100, as illustrated in FIG. 5, the light irradiation unit 70 is provided on the side of the counter substrate 140 opposite to the liquid crystal layer 130. The light detection unit 80 is provided on the side of the element substrate 110 opposite to the liquid crystal layer 130.

On the other hand, in the display device 200, as illustrated in FIG. 11, the light irradiation unit 70 is provided on the liquid crystal layer 130 side of the counter substrate 140. The light detection unit 80 is provided on the liquid crystal layer 130 side of the element substrate 110.

The light detection unit 80 is provided, for example, between the first support substrate 112 and the first alignment layer 118. The light irradiation unit 70 is provided, for example, between the partition portion 142 and the insulating layer 143. The partition portion 142 is not provided with the window portion 150.

In the display device 200, the light irradiation unit 70 is provided on the liquid crystal layer 130 side of the counter substrate 140, and the light detection unit 80 is provided on the liquid crystal layer 130 side of the element substrate 110. Therefore, with the display device 200, a short distance between the light irradiation unit 70 and the liquid crystal layer 130 and a short distance between the light detection unit 80 and the liquid crystal layer 130 can be achieved, as compared with, for example, the display device 100. Thus, the degradation of the liquid crystal panel 32 can be accurately detected. Furthermore, since the light irradiation unit 70 and the light detection unit 80 do not form the outer appearance of the liquid crystal panel 32, it is possible to eliminate restrictions on design due to the installation of the light irradiation unit 70 and the light detection unit 80.

### 2. Second Embodiment

### 2.1. Display Device

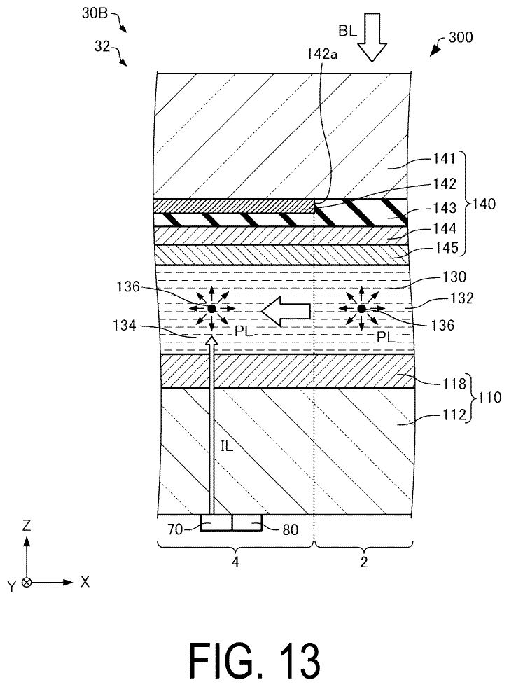

Next, a display device according to a second embodiment will be described with reference to the drawings. FIG. 12 is a plan view schematically illustrating a display device 300 according to the second embodiment. FIG. 13 is a cross-sectional view taken along the line XIII-XIII in FIG. 12, which schematically illustrates the display device 300 according to the second embodiment.

In the following description, in the display device 300 according to the second embodiment, members having the same functions as the constituent members of the display devices 100 and 200 described above are denoted by the same reference signs, and detailed description thereof is omitted.

In the display device 100, as illustrated in FIG. 4 and FIG. 5, the light irradiation unit 70 is provided on the liquid crystal layer 130 side of the element substrate 110. The counter substrate 140 is provided with the light detection unit 80.

On the other hand, in the display device 300, as illustrated in FIG. 12 and FIG. 13, the light irradiation unit 70 and the light detection unit 80 are provided on the element substrate 110. In the example illustrated in FIG. 13, the light irradiation unit 70 and the light detection unit 80 are provided on a side of the element substrate 110 opposite to the liquid crystal layer 130. Preferably, a distance between the light irradiation unit 70 and the light detection unit 80 is short. The light irradiation unit 70 and the light detection unit 80 may be in contact with each other. As viewed in the normal direction, the light detection unit 80 is provided closer to the display region 2 than the light irradiation unit 70, for example. The partition portion 142 is not provided with the window portion 150.

Although not illustrated, a light receiving surface of the light detection unit 80 may be inclined toward the light irradiation unit 70. Thus, the light PL can be efficiently detected. The light irradiation unit 70 may be provided closer to the display region 2 than the light detection unit 80.

In the display device 300, the light irradiation unit 70 and the light detection unit 80 are provided on a side of the element substrate 110 opposite to the liquid crystal layer 130. Therefore, in the display device 300, the light irradiation unit 70 and the light detection unit 80 can be easily arranged as compared with a case where the light irradiation unit and the light detection unit are arranged on different substrates.

Although not illustrated, the light irradiation unit 70 and the light detection unit 80 may be provided on the counter substrate 140.

### 2.2. Modification of Display Device

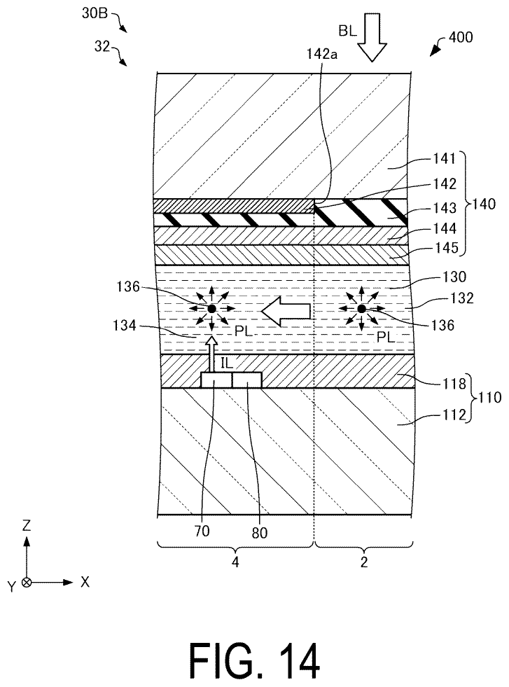

Next, a display device according to a modification of the second embodiment is described with reference to the drawing. FIG. 14 is a cross-sectional view schematically illustrating a display device 400 according to the modification of the second embodiment.

In the following description, in the display device 400 according to the modification of the second embodiment, members having the same functions as the constituent members of the display devices 100, 200, and 300 described above are denoted by the same reference signs, and detailed description thereof is omitted.

In the above display device 300, as illustrated in FIG. 13, the light irradiation unit 70 and the light detection unit 80 are provided on a side of the element substrate 110 opposite to the liquid crystal layer 130.

On the other hand, in the display device 400, as illustrated in FIG. 14, the light irradiation unit 70 and the light detection unit 80 are provided on the liquid crystal layer 130 side of the element substrate 110. The light irradiation unit 70 and the light detection unit 80 are provided, for example, between the first support substrate 112 and the first alignment layer 118.

In the display device 400, the light irradiation unit 70 and the light detection unit 80 are provided on the liquid crystal layer 130 side of the element substrate 110. Therefore, with the display device 400, a short distance between the light irradiation unit 70 and the liquid crystal layer 130 and a short distance between the light detection unit 80 and the liquid crystal layer 130 can be achieved, as in the display device 200.

### 3. Third Embodiment

### 3.1. Display Device

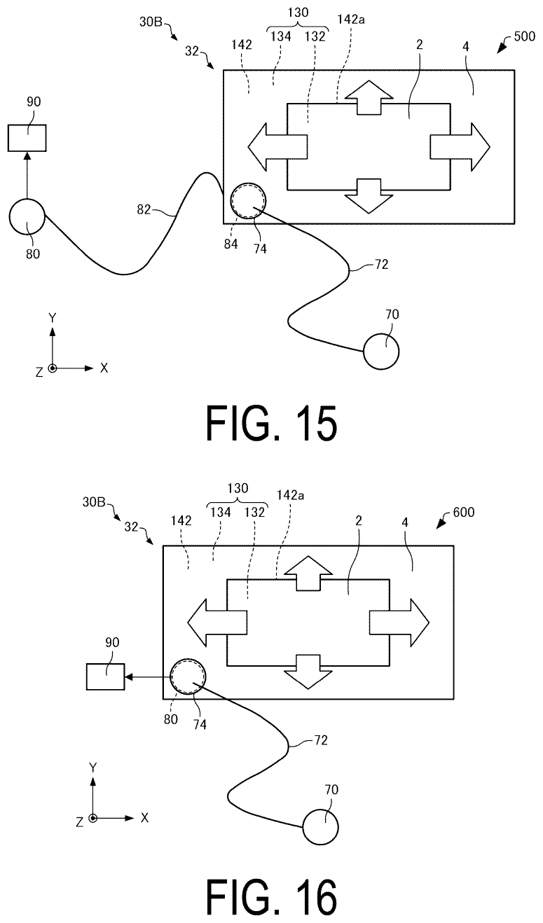

Next, a display device according to a third embodiment will be described with reference to the drawings. FIG. 15 is a plan view schematically illustrating a display device 500 according to the third embodiment.

In the following description, in the display device 500 according to the third embodiment, members having the same functions as the constituent members of the display devices 100, 200, 300, and 400 described above are denoted by the same reference signs, and detailed description thereof is omitted.

The display device 500 differs from the display device 100 described above in that a first light guide unit 72 and a second light guide unit 82 are provided as illustrated in FIG. 15. The display device 500 further includes, for example, a first light condensing unit 74 and a second light condensing unit 84.

The light irradiation unit 70 is separated from the liquid crystal panel 32. The first light guide unit 72 guides the light IL emitted from the light irradiation unit 70 to the second portion 134 of the liquid crystal layer 130. In the illustrated example, the light irradiation unit 70 and the first light condensing unit 74 are coupled through the first light guide unit 72. The first light guide unit 72 is an optical fiber.

The first light condensing unit 74 overlaps the second portion 134 of the liquid crystal layer 130 as viewed in the normal direction. The first light condensing unit 74 is provided on the counter substrate 140 for example. The first light condensing unit 74 condenses the light IL emitted from the first light guide unit 72, toward the second portion 134. Specifically, the first light condensing unit 74 condenses the light IL, emitted from a light emitting surface of the first light guide unit 72, toward the second portion 134. The first light condensing unit 74 is, for example, a condensing lens.

The second light condensing unit 84 overlaps the second portion 134 of the liquid crystal layer 130 as viewed in the normal direction. The second light condensing unit 84 overlaps the first light condensing unit 74 as viewed in the normal direction. The element substrate 110 is provided with the second light condensing unit 84 for example. The second light condensing unit 84 condenses the light PL emitted from the second portion 134, toward the second light guide unit 82. Specifically, the second light condensing unit 84 condenses the light PL emitted from the second portion 134, toward the light incident surface of the second light guide unit 82. The second light condensing unit 84 is, for example, a condensing lens.

The light detection unit 80 is separated from the liquid crystal panel 32. The second light guide unit 82 guides the light PL emitted from the second portion 134 of the liquid crystal layer 130 to the light detection unit 80. In the illustrated example, the second light condensing unit 84 and the light detection unit 80 are coupled through the second light guide unit 82. The second light guide unit 82 guides the light PL condensed by the second light condensing unit 84 to the light detection unit 80. The second light guide unit 82 is an optical fiber.

The display device 500 includes the first light guide unit 72 configured to guide the light IL of the first wavelength band emitted from the light irradiation unit 70 to the second portion 134 of the liquid crystal layer 130 and the second light guide unit 82 configured to guide the light PL of the long wavelength band emitted from the second portion 134 of the liquid crystal layer 130 to the light detection unit 80. Therefore, in the display device 500, the light irradiation unit 70 and the light detection unit 80 do not need to be directly disposed on the liquid crystal panel 32, and thus it is possible to increase the degree of freedom in design.

The display device 500 includes the first light condensing unit 74 configured to condense the light IL of the first wavelength band emitted from the first light guide unit 72, toward the second portion 134 of the liquid crystal layer 130 and the second light condensing unit 84 configured to condense the light PL of the long wavelength band emitted from the second portion 134 of the liquid crystal layer 130, toward the second light guide unit 82. Therefore, in the display device 500, the light IL of the first wavelength band can be efficiently made incident on the second portion 134 and the light PL of the long wavelength band can be efficiently made incident on the second light guide unit 82.

Although not illustrated, both the first light condensing unit 74 and the second light condensing unit 84 may be provided on the element substrate 110, or both the first light condensing unit 74 and the second light condensing unit 84 may be provided on the counter substrate 140.

### 3.2. Modification of Display Device

Next, a display device according to a modification of the third embodiment is described with reference to the drawing. FIG. 16 is a plan view schematically illustrating a display device 600 according to the modification of the third embodiment.

In the following description, in the display device 600 according to the modification of the third embodiment, members having the same functions as the constituent members of the display devices 100, 200, 300, 400, and 500 described above are denoted by the same reference signs, and detailed description thereof is omitted.

As illustrated in FIG. 15, the display device 500 includes the first light guide unit 72, the second light guide unit 82, the first light condensing unit 74, and the second light condensing unit 84.

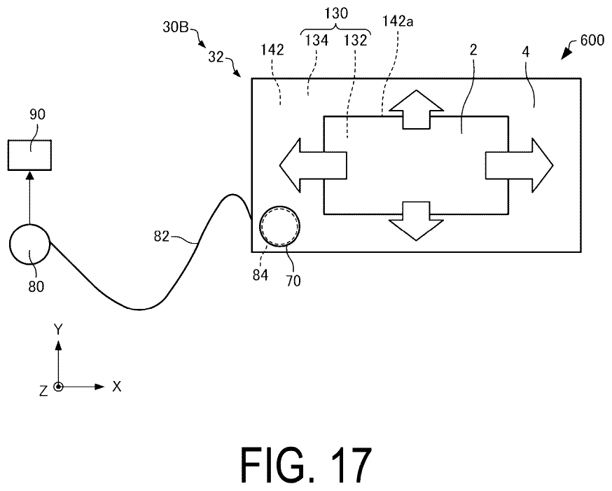

On the other hand, as illustrated in FIG. 16, the display device 600 includes the first light guide unit 72 and the first light condensing unit 74, and does not include the second light guide unit 82 and the second light condensing unit 84. As illustrated in FIG. 17, the display device 600 may include the second light guide unit 82 and the second light condensing unit 84 and may not include the first light guide unit 72 and the first light condensing unit 74.

The embodiment and the modifications described above are merely examples, and are not intended as limiting. For example, each embodiment and each modification can also be combined together as appropriate.

The present disclosure includes configurations that are substantially identical to the configurations described in the embodiment, for example, configurations with identical functions, methods and results, or with identical advantages and effects. Also, the present disclosure includes configurations obtained by replacing non-essential portions of the configurations described in the embodiment. In addition, the present disclosure also includes configurations that achieve the same effects as the configurations described in the embodiments or configurations that can achieve the same advantages. Further, the present disclosure includes configurations obtained by adding known techniques to the configurations described in the embodiment.

The following contents are derived from the embodiment and the modifications described above.

A display device according to an aspect includes
a light source;
a liquid crystal panel including
   a display region on which light emitted from the light source is incident, the display region including a first substrate and a second substrate provided facing each other, and a liquid crystal layer provided between the first substrate and the second substrate, and
   a peripheral region in periphery of the display region;
a light irradiation unit configured to irradiate, with light of a first wavelength band, a portion of the liquid crystal layer overlapping the peripheral region as viewed in a normal direction of the first substrate; and
a light detection unit configured to detect light of a long wavelength band longer than the first wavelength band emitted from the portion of the liquid crystal layer, when the light irradiation unit irradiates the portion of the liquid crystal layer with the light of the first wavelength band.

According to this display device, it is possible to efficiently detect degradation of the liquid crystal panel.

In the display device according to an aspect, the light irradiation unit and the light detection unit may overlap the portion of the liquid crystal layer as viewed in the normal direction.

According to this display device, incidence of the light that is emitted from the light source on the light detection unit can be suppressed.

In the display device according to an aspect,
the light irradiation unit may be provided on a side of the second substrate opposite to the liquid crystal layer, and
the light detection unit may be provided on a side of the first substrate opposite to the liquid crystal layer.

According to this display device, it is possible to reduce an impact of the installation of the light irradiation unit and the light detection unit on the liquid crystal layer.

In the display device according to an aspect,
the light irradiation unit may be provided on a liquid crystal layer side of the second substrate, and
the light detection unit may be provided on a liquid crystal layer side of the first substrate.

According to the display device, it is possible to achieve a short distance between the light irradiation unit and the liquid crystal layer and a short distance between the light detection unit and the liquid crystal layer.

In display device according to an aspect, the light irradiation unit and the light detection unit may be provided on a side of the first substrate opposite to the liquid crystal layer.

According to the display device, the light irradiation unit and the light detection unit can be easily arranged.

In the display device according to an aspect, the light irradiation unit and the light detection unit may be provided on a liquid crystal layer side of the first substrate.

According to the display device, it is possible to achieve a short distance between the light irradiation unit and the liquid crystal layer and a short distance between the light detection unit and the liquid crystal layer.

The display device according to an aspect may further include
a first light guide unit configured to guide the light of the first wavelength band emitted from the light irradiation unit to the portion of the liquid crystal layer, and
a second light guide unit configured to guide the light of the long wavelength band emitted from the portion of the liquid crystal layer to the light detection unit.

According to the display device, a degree of freedom in design can be improved.

The display device according to an aspect may further include
a first light condensing unit configured to condense the light of the first wavelength band emitted from the first light guide unit, toward the portion of the liquid crystal layer, and
a second light condensing unit configured to condense the light of the long wavelength band emitted from the portion of the liquid crystal layer, toward the second light guide unit.

According to the display device, the light of the first wavelength band can be efficiently made incident on the portion of the liquid crystal layer, and the light of the long wavelength band can be efficiently made incident on the second light guide unit.

A control method for a display device according to an aspect is a control method for a display device including a light source, a liquid crystal panel including a display region on which light emitted from the light source is incident and a peripheral region in periphery of the display region, and a light irradiation unit, wherein the display region includes a first substrate and a second substrate provided facing each other, and a liquid crystal layer provided between the first substrate and the second substrate, and the light irradiation unit is configured to irradiate, with light of a first wavelength band, a portion of the liquid crystal layer overlapping the peripheral region as viewed in a normal direction of the first substrate. The method comprises detecting light of a long wavelength band longer than the first wavelength band emitted from the portion of the liquid crystal layer, when the light irradiation unit irradiates the portion of the liquid crystal layer with the light of the first wavelength band.

According to this control method for the display device, it is possible to efficiently detect degradation of the liquid crystal panel.

What is claimed is:

1. A display device comprising:
a light source;
a liquid crystal panel including
a display region on which light emitted from the light source is incident, the display region including a first substrate and a second substrate provided facing each other, and a liquid crystal layer provided between the first substrate and the second substrate, and
a peripheral region in periphery of the display region;
a light irradiation unit configured to irradiate, with light of a first wavelength band, a portion of the liquid crystal layer overlapping the peripheral region as viewed in a normal direction of the first substrate; and
a light detection unit configured to detect light of a long wavelength band longer than the first wavelength band emitted from the portion of the liquid crystal layer, when the light irradiation unit irradiates the portion of the liquid crystal layer with the light of the first wavelength band.

2. The display device according to claim 1, wherein the light irradiation unit and the light detection unit overlap the portion of the liquid crystal layer as viewed in the normal direction.

3. The display device according to claim 2, wherein
the light irradiation unit is provided on a side of the second substrate opposite to the liquid crystal layer, and
the light detection unit is provided on a side of the first substrate opposite to the liquid crystal layer.

4. The display device according to claim 2, wherein
the light irradiation unit is provided on a liquid crystal layer side of the second substrate, and
the light detection unit is provided on a side crystal layer side of the first substrate.

5. The display device according to claim 2, wherein the light irradiation unit and the light detection unit are provided on a side of the first substrate opposite to the liquid crystal layer.

6. The display device according to claim 2, wherein the light irradiation unit and the light detection unit are provided on a liquid crystal layer side of the first substrate.

7. The display device according to claim 1, further comprising:
a first light guide unit configured to guide the light of the first wavelength band emitted from the light irradiation unit to the portion of the liquid crystal layer; and
a second light guide unit configured to guide the light of the long wavelength band emitted from the portion of the liquid crystal layer to the light detection unit.

8. The display device according to claim 7, further comprising:
a first light condensing unit configured to condense the light of the first wavelength band emitted from the first light guide unit, toward the portion of the liquid crystal layer; and
a second light condensing unit configured to condense the light of the long wavelength band emitted from the portion of the liquid crystal layer, toward the second light guide unit.

9. A control method for a display device including a light source, a liquid crystal panel including a display region on which light emitted from the light source is incident and a peripheral region in periphery of the display region, and a light irradiation unit, wherein the display region includes a first substrate and a second substrate provided facing each other, and a liquid crystal layer provided between the first substrate and the second substrate, and the light irradiation unit is configured to irradiate, with light of a first wavelength band, a portion of the liquid crystal layer overlapping the peripheral region as viewed in a normal direction of the first substrate, the method comprising:
detecting light of a long wavelength band longer than the first wavelength band emitted from the portion of the liquid crystal layer, when the light irradiation unit irradiates the portion of the liquid crystal layer with the light of the first wavelength band.
